(19) United States
(12) Patent Application Publication
(10) Pub. No.: US 2008/0315446 A1
(43) Pub. Date: Dec. 25, 2008

(54) Method and Device for Controlling the Quality During the Production of an Extruded Polymer Product

(76) Inventors: Reinhard Muhlenmeister, Remscheid (DE); Marcel Bornheim, Koln (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/573,252

(22) PCT Filed: Jul. 29, 2005
(86) PCT No.: PCT/EP2005/008245

§ 371 Date: Aug. 29, 2008

(30) Foreign Application Priority Data
Jul. 31, 2004 (DE) 10 2004 037 263.2

(51) Int. Cl. B29C 47/92

(52) U.S. Cl. 264/40.7; 425/135

(57) ABSTRACT

A method and a device for controlling the quality during the production of an extruded polymer product from a synthetic intermediate product. The production of the polymer product takes place continuously in several successive process steps; whereby a process parameter and/or a product parameter is/are detected in at least one of the process steps and is/are compared with a target value or target value range. A quality signal for determining the quality of the polymer product and/or a control signal for controlling one of the process steps is generated in accordance with this comparison. According to the invention, a measuring time and a throughput time are assigned to the process parameter and/or the product parameter, the throughput time characterizing the current material flow for the respective process step up to the production of the finished polymer product. Changes in quality can thus be identified in advance and can be taken into account for statistical process control.

### BACKGROUND OF THE INVENTION

The invention relates to a method for controlling the quality during the production of an extruded polymer product, and a device for implementing said method. A method of this type has been disclosed in EP 0 644 282 A1.

According to the known method, in a production process for synthetic threads, at least one process parameter or product parameter is measured and compared with predetermined target values or tolerance bands for the purpose of process control and quality control. Based on the comparison, a control signal for influencing the process control or a quality signal determining the quality of the end product is generated. Here, the known method aims particularly at using the measurements performed at a reference station in order to control several processing stations with the help of the control signal.

Another method for monitoring a production process of a synthetic thread has been disclosed in WO 94/25869, in which method at least two process parameters are measured consecutively and compared with target value ranges. As soon as at least two impermissible deviations of the process parameters are determined, a quality signal is generated which is linked to the produced end product and is used for the process control.

In contrast, DE 199 11 704 A1 discloses a method in which a quality signal is determined continuously from the fluctuations in the measured values of a process or product parameter and this quality value is assigned to the thread. Here, the fluctuations in the measured values of a defined time segment are taken into account.

In the methods known from the prior art, the isochronously determined measured values of the process parameters and product parameters are used substantially in order to determine the current quality of the end product. However, the disadvantage of this procedure is that the fluctuations in the measured values of the process parameters, for example, said fluctuations occurring in the melt preparation system, affect the end product only with a time delay and thus result in a falsification of the quality signals. In addition, the process control is based on the fact that the correcting control of the process for improving the quality can take place only after the event in accordance with determined process irregularities.

It is now an object of the invention to provide a method of the generic kind for controlling the quality during the production of an extruded polymer product and a device for implementing a method of this type, in which an extruded polymer product can be produced in several process steps with a determinable quality.

Another object of the invention is to provide a method for the controlling the quality during the production of an extruded polymer product and a device for implementing said method using which a flexible process control is possible, which is geared to the actually produced product quality.

It is likewise an object of the invention to further improve the method of the generic kind for controlling the quality in such a way that complex productions having a plurality of process steps starting from the primary product up to the polymer product can be carried out safely.

### SUMMARY OF THE INVENTION

The above objectives and others are realized according to the invention by providing, in one embodiment, a method for controlling the quality during the production of an extruded polymer product from a synthetic primary product, in which the production of the polymer product takes place continuously in several successive process steps, the method comprising detecting at least one of a process parameter or a product parameter in at least one of the process steps, and comparing the process parameter or product parameter with one of a target value or target value range, wherein one of at least one quality signal for determining the quality of the polymer product or a control signal for controlling one of the process steps is generated in accordance with this comparison, and wherein a measuring time and a throughput time are assigned to the process parameter or product parameter, the throughput time characterizing the material flow from the respective process step up to the production of the finished polymer product.

In another embodiment, the present invention provides a method that comprises detecting at least one of a process parameter or a product parameter in at least one of the process steps, and comparing the process parameter or product parameter with one of a target value or target value range, wherein one of at least one quality signal for determining the quality of the polymer product or a control signal for controlling one of the process steps is generated in accordance with this comparison, wherein a determination time is assigned to the quality signal or control signal, and wherein when determining the quality signal or control signal, at least one of the process parameter, the product parameter, or the deviation of the process parameter or the product parameter from the target value or the target value range is consulted, where the process parameter, the product parameter, or the deviation thereof was detected in terms of time while taking into account the material flow at a throughput time before the determination time.

The above objectives and others are also realized according to the invention by providing, in one embodiment, a device for controlling the quality during the production of an extruded polymer product from a synthetic primary product, the device comprising a production plant for a polymer product, which is generated from at least one synthetic primary product and comprises a plurality of process modules, a central process coordinating control system, which is connected to the process modules by means of a control and monitoring network, wherein a sensor means is assigned to at least one of the process modules for detecting at least one of a process parameter or product parameter, wherein the process coordinating control system comprises a memory means for recording at least one of a target value or a target value range of the process parameter or product parameter, and an evaluation electronic system for generating at least one of a quality signal or a control signal, wherein within the process coordinating control system, a means for digitizing the measuring signals with the measuring time and measuring point data is assigned to the sensor means, and wherein the memory means has a time register, in which at least one place-dependent throughput time is stored, wherein the throughput time characterizes material flow from the related process module up to the production of the finished polymer product.

The invention is based on the realization that in the production of an extruded product, the process steps carried out in each case from the primary product up to the end product become noticeable in the end product at different sequences of time. Thus, for example, in the production of a synthetic thread, a process deviation in the preparation of the primary product have an effect at a substantially later point in time than a process deviation when winding the thread. By means of the method according to the invention, it is possible to ensure that in the generation of the quality signals and/or control signals, only the relevant measured variables are used for determining the actual product quality. For this purpose, a measuring time and a throughput time are assigned to the process parameter and/or the product parameter. The throughput time characterizes the current material flow from the respective process step up to the final polymer product. Thus, the product quality of the polymer product, which product quality can be expected after the lapse of the throughput time, can be predicted advantageously from a measured process parameter within the process chain. Thus, process controls are possible with respect to future changes in quality of the polymer product.

However, another aspect of the invention is that the actually produced product quality can be determined at every point in time during the production of the polymer product. For this purpose, a determination time is assigned to the quality signal or the control signal, in order to be able to consult the process parameters and/or the product parameters or the deviation of the process parameter and/or the product parameter from the predetermined target value or the target value range, when determining the quality signal and/or control signal, which process parameters and/or product parameters or the deviation thereof were detected in terms of time while taking into account the material flow at a throughput time before the determination time. Thus, quality values can be generated advantageously and assigned to the final product directly, in order to be used, for example, for a subsequent treatment process.

In a production process, in which the production speed is substantially held constant, that variant of the inventive method can be used preferably, in which a measuring point is assigned to the process parameter and/or the product parameter, using which measuring point the throughput time can be determined.

If several process parameters and/or several product parameters are detected, the respective measuring time and the respective throughput time are advantageously assigned to each process parameter and each product parameter. Thus, each process parameter and each product parameter within the process chain are identifiable by a measuring time and a respective throughput time or alternatively by a respective measuring point.

For the continuous quality control it is particularly advantageous to detect and store the process parameters and/or the product parameters consecutively.

In principle, the quality signal or the control signal can be generated in the presence of several process parameters or product parameters by using different variants of the inventive method. In a first variant, only those process parameters and/or product parameters are consulted, which were measured at the same point in time. Thus, it is possible to draw conclusions about several successive process steps or even the entire process chain. Thus, it is also possible to advantageously control process steps, which jointly control, for example, the stretching and drawing of a thread due to very high production speeds.

The variant of the inventive method, in which the process parameters and/or product parameter having the same throughput time are consulted for generating the quality signal and/or the control signal, is particularly suitable in order to indicate future quality changes and bring about appropriate process changes. Here it is possible to both directly control the process step assigned to the process parameters or to control the last process step for the final completion of the polymer product with a time delay.

In order to be able to predict the produced product quality, that variant of the inventive method is particularly suitable in which for generating the quality signal and/or the control signal, those process parameters and/or product parameter are consulted, whose measuring time and throughput time result in an identical future determination time. Thus, all the process parameters or product parameters detected within the process chain can be intended for determining the quality of the polymer product to be produced.

In the production of extruded polymer products, the latter are indicated preferably with quality levels after completion. Thus, when producing synthetic threads it is known to classify the threads wound up into a spool as A-quality, B-quality or C-quality, A representing the maximum possible product quality. Such a weighting can be taken into account advantageously in the case of an actual/target comparison of the process parameters and/or product parameters. Here, according to a particularly preferred variant of the inventive method, several target values or target value ranges are assigned to the process parameter and/or the product parameter so as to enable a weighting of the deviation of the process parameters and/or the product parameters.

The specifications of the target values and/or target value ranges can be changed for improving the flexibility of the method. Likewise, the generation of the quality signal or the control signal can be influenced by manual interferences by means of an operating unit. Thus, defined process parameters of a process chain can be optionally eliminated, in order to detect their effect on a quality signal or a control signal. Likewise, alternative algorithms can be stored, which are used optionally for evaluating the quality or for process control.

If in the production process, the extruded polymer product is formed by a thread, which is wound up in a last process step to form a spool, that variant of the inventive method shows a particularly high flexibility of the process control, in which the changes in the quality of the thread arising within a winding time are used directly for carrying out a change of the spool. Thus, in particular, short-term process fluctuations, which can lead to a defective quality or a worse quality of the thread, can be advantageously accommodated in a partly wound spool and eliminated.

For implementing the method according to the invention, the device according to the invention advantageously comprises a process coordinating control system, in which a means for digitizing the measuring signals with measuring time and measuring point data is assigned to the sensor means connected to the process coordinating control system. The memory means provided in the process coordinating control system additionally contains a time register, by means of which a throughput time can be assigned to each measuring point. The place-dependent throughput time is stored in the time register.

To influence the quality control or the process control, according to an advantageous improvement of the device according to the invention, the process coordinating control system is designed with an interface, to which a manual operating unit is connected. Using the manual operating unit, it is possible to enter the specifications of the target values and the target value ranges and also the throughput times in the time register.

For the purpose of display, the process coordinating control system has another interface, which is connected to an output unit. The output unit, which can be formed for example, by a microprocessor with a monitor, can display the process parameters, product parameters or quality signals in their courses during the process. Thus, higher-level manual interventions are also possible for process control.

In order for one operating person to be able to implement the entire process chain with respect to its process control and the quality determination, the output unit is advantageously combined with the operating unit.

### BRIEF DESCRIPTION OF THE DRAWINGS

Having thus described the invention in general terms, reference will now be made to the accompanying drawings, which are not necessarily drawn to scale, and wherein:

FIG. 1 is a diagram of a device according to the invention for implementing the method according to the invention during the production of an extruded polymer product;

FIG. 2 shows schematically a control scheme for the process flow of the production process shown in FIG. 1;

FIG. 3 schematically shows the course of a process parameter during the production of an extruded polymer product; and

FIG. 4 schematically shows an exemplary embodiment of the device according to the invention for producing a plurality of synthetic threads.

### DETAILED DESCRIPTION OF THE INVENTION

The present invention now will be described more fully hereinafter with reference to the accompanying drawings, in which some, but not all embodiments of the invention are shown. Indeed, the present invention may be embodied in many different forms and should not be construed as limited to the embodiments set forth herein; rather, these embodiments are provided so that this disclosure will satisfy applicable legal requirements. Like numbers refer to like elements throughout.

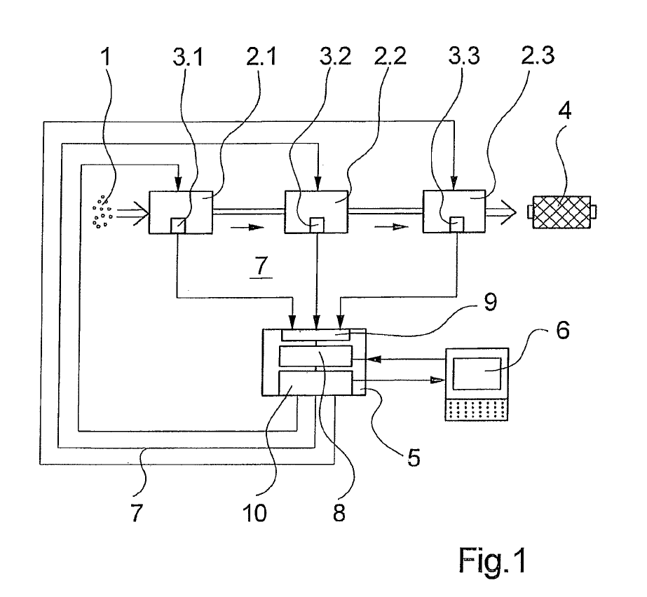

FIG. 1 shows a diagram of a device according to one embodiment of the invention for implementing a method according to one embodiment of the invention. Here, several process modules 2.1, 2.2 and 2.3 form a production plant. The process modules 2.1, 2.2 and 2.3 form a process chain for the production of an extruded polymer product. For this purpose, an primary product 1 is supplied to the production process, for example, in the form of a plastic granulate and is passed through the process modules 2.1, 2.2 and 2.3 to form a final extruded polymer product 4, for example, a thread wound on a spool. At least one sensor means 3.1, 3.2 and 3.3 is assigned to each of the process modules 2.1, 2.2 and 2.3. In principle, the process modules 2.1, 2.2 and 2.3 contain several process aggregates in order to be able to carry out one process step within the entire process chain. Here, for example, the process module 2.1 could carry out the preparation of the plastic granulate. The process aggregates for melting and for preparing the melt could be arranged in the process module 2.2. A melt-spinning device having a winding device could form the process module 2.3.

However, there can be any number of process modules and they can have an arbitrary design so as to be able to produce all the well-known extruded polymer products, such as for example, spin cables, staple fibers, film strips, carpet yarns, technical threads or textile threads.

A central process coordinating control system 5 is provided for monitoring and controlling the production plant. The process coordinating control system 5 is coupled to the process modules 2.1, 2.2 and 2.3 as well as to the sensor means 3.1, 3.2 and 3.3 by means of a control and monitoring network 7. The control and monitoring network 7 can be formed by a BUS system here.

The structure of the process coordinating control system 5 is described in the following only with reference to the means required for implementing a method according to one embodiment of the invention. A digitizing means 9, a memory means 8 and an evaluation electronic system 10 are contained within the process coordinating control system 5. The digitizing means 9 is assigned to the sensor means 3.1, 3.2 and 3.3 in order to be able to digitize the measuring signals with the measuring time and measuring point data. Here, the measuring point data can be determined by means of address codes assigned to the sensor means 3.1, 3.2 and 3.3. The incoming measuring signals are recorded in the memory means 8 after the digitization. The memory means 8 contains additionally a time register, in which place-dependent throughput times are stored. The respective throughput times characterize the duration of the material flow from the respective process module or from the respective measuring point to the final production of the finished polymer product. The memory means 8 is linked to the evaluation electronics system 10, with the result that when the measuring signals and the time register are read out, a throughput time is assigned to each of the actual values of the process parameters and/or product parameters, said actual values being detected by the measuring signals. On the basis of the target values or target value ranges that are likewise read out, it is now possible to perform an evaluation in accordance with predetermined algorithms and this evaluation can be used for generating a quality signal or a control signal. The evaluation electronics unit 10 can directly generate control signals, which can be supplied to the related process modules 2.1, 2.2 or 2.3 by means of the control and monitoring network 7. The quality signal generated by the evaluation electronics system 10 is preferably supplied to an output unit 6. For this purpose, the process coordinating control system 5 is coupled to an output/operating unit 6 by means of an interface. The output/operating unit 6 contains a manual control panel, by means of which a manual intervention is possible. Thus, for example, specifications of target values or changes in the throughput time can be entered using said manual control panel. Furthermore, specifications for evaluating defined quality signals can be also given.

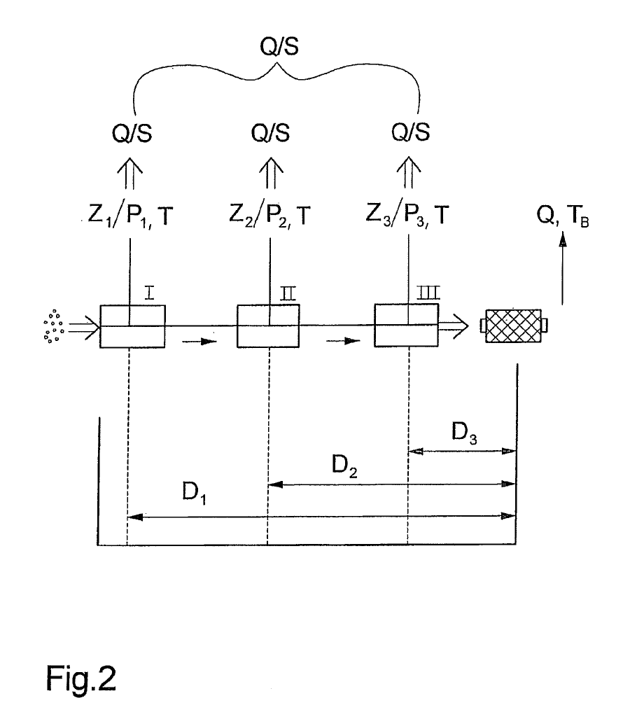

One may refer to the control scheme shown in FIG. 2 for the explanation of the inventive method, which can be implemented using the exemplary embodiment of the inventive device shown in FIG. 1. In the control scheme shown in FIG. 2, the process modules are identified with the individual process steps I, II and III. Individual or several process parameters or individual or several product parameters can be detected by means of several sensors within each process step. For this purpose, the sensor means assigned to the process modules comprise several sensors, which detect, for example, rotational speeds, pressures, setting parameters or temperatures. Thus, for example, a process parameter Zl and/or a product parameter Pl could be measured at a measuring time T in the process step I. Alternatively or additionally, another process parameter Z2 and/or a product parameter P2 could be detected at the measuring time T in the process step II. Accordingly, a process parameter Z3 and/or a product parameter P3 are detected at the measuring time in the process step III.

However, assuming that all the process parameters and product parameters were detected at the same measuring time T, the individual process parameters Z and the individual product parameters P only have a delayed effect on the final production of the finished polymer product 4. Provided that the production is carried out at defined production speeds, the material flow from the primary product 1 up to the polymer product 4 results in throughput times between the individual process steps I, II and III and the final polymer product 4. Thus the product parameter Pl detected at the measuring time T in the process step I will become noticeable in the polymer product 4 only after the lapse of a throughput time of D1. Accordingly irregularities in the process step II affect the final polymer product 4 after the lapse of the throughput time D2 and irregularities in the process step III affect the final polymer product 4 after the lapse of the throughput time D3.

The method according to invention can now be used advantageously in order to carry out an evaluation of the measuring signals for each of the process steps. Thus the process parameters Zl and product parameter Pl measured in the process step I are compared with stored target values or target value ranges. The resulting differences can be transferred directly into a quality signal Q and/or a control signal S. Here, it is preferred to generate control signals, which directly enable an intervention in the related process step. A quality signal derived therefrom is used, in order to show the future process flow with respect to the quality of the polymer product 4.

Similarly, the process parameters Z2 and Z3 measured in the process steps II and III as well as the measured product parameters P2 and P3 could be supplied directly to an evaluation electronic system, in order to enable a rapid intervention in the respective process step in the case of impermissible deviations of the parameters. Both individual quality signals and individual control signals can be determined independently of one another for the individual process steps.

Alternatively, however, it is also possible to incorporate several process parameters and/or product parameters of several process steps in an evaluation. Such a variant of the inventive method is particularly recommended during complex processes in which there is a mutual influence of the process steps. Thus, for example, deviations in a proceeding process step can be compensated by appropriate countermeasures in the subsequent process step. The control signal generated from the sum evaluation can thus be used for controlling one or all the process steps. The quality signal Q generated permits a preview, in particular, of the produced product quality.

However, the method according to the invention can also be used advantageously in order to perform a quality determination of the polymer product 4 in real time. During the on-line determination of the quality of the polymer product 4, at first a determination time TB is specified, by means of which the process parameters or the product parameters relevant for the quality determination are defined distinctly. Taking into account the respective throughput times, it is possible to select, for the purpose of quality determination, those process parameters or product parameters, which were detected exactly at the respective throughput time before the determination time TB. Thus, for example, the process parameter and/or product parameter in the process step III is used, which was detected at the measuring time T=TB−D3. Accordingly, the measuring time T=TB−D2 applies to the process/product parameters of the process step II and the measuring time T=TB−D1 applies to the process step I.

By reading out the correspondingly identified measured values, it is possible to perform an evaluation which takes into account the totality of the parameters that played a part in the polymer product at the determination time TB. The quality signals thus generated correspond to the actual quality of the end product.

The quality signals are thus particularly suitable for being documented and allocated to the polymer product so as to be able to adapt the subsequent treatment process to the actual quality of the polymer product.

The method according to the invention thus results in high flexibility with respect to the process control and quality control. Thus process changes brought about by occurring fluctuations in quality can be taken into account in advance.

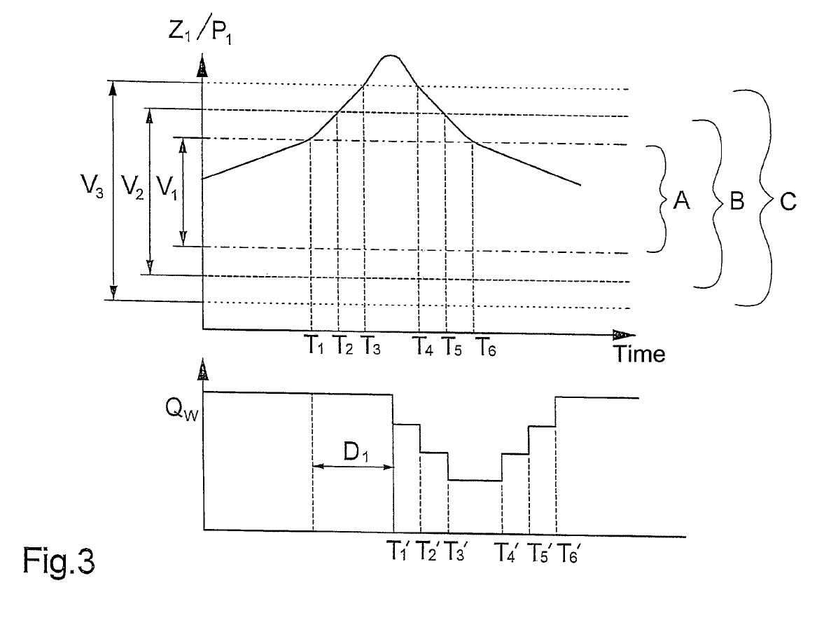

In order to enable a continuous production process of the polymer product having the highest quality possible, the process parameters and the product parameters are detected consecutively and compared with target values or target value ranges. The course of a process parameter or a product parameter is shown schematically in FIG. 3 for the purpose of further explanation.

The value of a process parameter Zl or alternatively a product parameter Pl is plotted on the ordinate in an upper diagram in FIG. 3. The abscissa of the graph represents the time axis and thus the process flow. A quality value QW is plotted on the ordinate in the lower diagram, wherein the abscissa indicates identical time axes.

A total of three target value ranges of the parameter are drawn in the form of tolerance bands in the upper graph. The first tolerance band V1 is indicated by the dash-dotted lines and represents the narrowest range for the value of the process parameter or the product parameter. The tolerance ranges V2 and V3 permit larger fluctuations of the process parameter or the product parameter in each case. Such a specification already enables a weighting of the process deviation. Thus, for example, the target value range Vl of the process parameter or the product parameter could be used in order to define the highest quality level having the designation A. Accordingly, the target value range V2 would provide a graded quality with the designation B and the target value range V3 a further gradation of the quality with the level C.

The course of the actual value of the process parameter Zl or the product parameter Pl is plotted in the upper graph. The course shows that the actual value of the parameter leaves the target value range Vl at the measuring time T1. In this respect, this would lead to a reduction in quality of the final product from level A to level B. A further transgression above the target value range V2 occurs already after the measuring time T2, and even a transgression above the largest target value range V3 occurs after the measuring time T3. Thus, a further quality gradation up to a lack of quality can thus be expected for the end product. The course of the actual value shows a value lying in the target value range V3 only after a time T4. Thus, in the period between the measuring time T3 and T4, an impermissible deviation of the process parameter and/or product parameter would be determined, which results in a lack of quality in the final product. However, the effects on the final product become noticeable only after the lapse of the throughput time D1.

For the purpose of illustration, the course of a quality value of the polymer product is plotted in the lower graph. At the point in time T1, a fibrous product is still generated, which has the highest product quality with the level A. The influence of the transgression of the target value becomes noticeable in the polymer product only at a time T1′. The throughput time D1 lies between the measuring time T1 and the time T1′. The changes in the quality levels will thus occur in the fibrous product with a time delay. The advantages of the method according to the invention can be seen in the course, shown in FIG. 3, of the process parameter or the product parameter. Thus, the consecutive monitoring and evaluation of the process parameter already permits the generation of a control signal, which works directly against the change of process in the first process step, with the result that the impermissible deviation of the process parameter has only short-term effects. The simultaneous generation of the quality signal makes it possible to detect directly the time at which a deterioration in quality can be expected in the end product. Furthermore, additional process changes can be derived, in order to allow for changes in quality, for example, when storing the polymer product. Thus, for example, the polymer product of a quality level A can be produced up to the time T1′. The polymer product produced in the period between the times Tl′ and T6′ could be stored separately. An A-level quality would be generated again only after reaching the time T6′.

The exemplary embodiment in FIG. 3 of a course of a process parameter and/or a product parameter is shown by way of example. In the monitoring and generation of control signals and quality signals, it is also common practice to include delay times, which permit, for example, a transgression of a target value range at first and enable an evaluation and an intervention only after the lapse of a delay time.

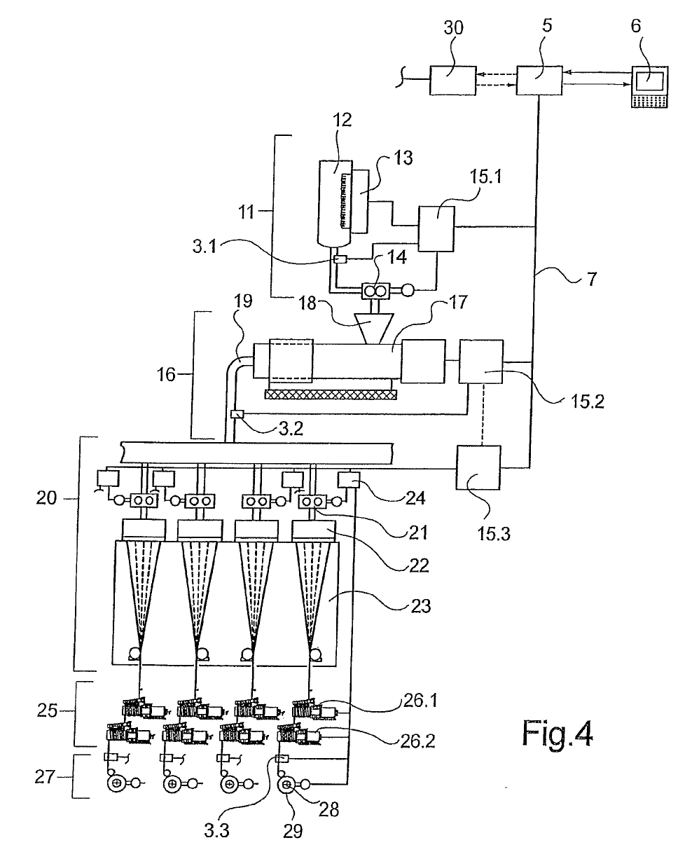

FIG. 4 schematically illustrates an exemplary embodiment of a production process for melt-spun threads. A plurality of threads of a thermoplastic primary product are spun in the production process and wound up to form spools. For this purpose, the thermoplastic primary product is previously conditioned in a granulate preparation system 11. The granulate preparation system 11 substantially comprises both a drier 12, having a heating system 13, and a metering system 14. A machine controller 15.1 is provided to control the granulate preparation system 11. Here, a sensor means 3.1 is assigned to the machine controller 15.1, which sensor means detects the degree of dryness of the granulate discharged from the drier 12.

The measured dried granulate is supplied to a melt preparation system 16. The melt preparation system 16 substantially consists of an extruder 17 to which the granulate is then supplied via a filler neck 18. An extruder screw is driven within the extruder 17 so as to melt the granulate and discharge it via a melt line 19 at the outlet of the extruder 17. The melt preparation system 16 is monitored and controlled via the machine controller 15.2, wherein a sensor means 3.2 is designed as a pressure sensor and it detects the melt pressure in the melt line 19.

A spinning apparatus 20, a treatment device 25 and a winding device 27 are provided for the melt-spinning, treatment and winding of the threads. The spinning apparatus 20, in detail, comprises a multiplicity of spinning pumps 21 which supply the melt to a multiplicity of spinning heads 22. Each of the spinning heads 22 comprises a multiplicity of spinning nozzles, only one spinning nozzle per spinning head being shown in FIG. 4. A cooling device 23 beneath the spinning head then cools the freshly extruded fibers.

In this exemplary embodiment, the treatment apparatus 25 consists of two roller units 26.1 and 26.2, which stretch the threads.

The winding device 27 comprises, for each spinning head, at least one spool spindle 28, on the circumference of which a plurality of spools 29 are formed simultaneously. Each stretched thread is thus wound up as the polymer product to form respectively one spool 29.

For each spinning head, the spinning apparatus 20, the treatment apparatus 25 and the winding device 27 are monitored and controlled by a spinning-head controller 24. In this case, the majority of the spinning-head controllers 24 are coupled to a master machine controller 15.3 via a BUS system.

Several sensors are assigned to each spinning-head controller 24, only one sensor means 3.3 being illustrated by way of example in this exemplary embodiment in the form of a thread tension sensor.

The machine controllers 15.1, 15.2 and 15.3 are connected to a process coordinating control system 5. The process coordinating control system 5 is used to control and monitor the entire production process from the primary product to the polymer end product. Here, the granulate preparation system 11, the melt preparation system 16, the spinning apparatus 20, the treatment device 25 and the winding device 27 each represent a process module, in which a process step is carried out. The sensor means in the process modules 11, 16, 20, 25 and 27 have been illustrated only by way of example here. In principle, process modules of such type comprise several sensors for monitoring the production process. DE 199 11 704 A1, for example, describes a process for the production of a synthetic thread and discloses a system for monitoring the product and machine parameters. To this extent, one may refer to the cited publication.

The process coordinating control system 5 is connected via an interface to an output/operating unit 6. For data exchange, the process coordinating control system 5 could further be coupled to a master control system 30. Specifications for producing and monitoring the production process can be given directly by the control system 30 to the process coordinating control system 5.

The signals generated using the sensor means 3.1, 3.2 and 3.3 are supplied directly to the process coordinating control system 5 by means of the respective machine controllers 15.1, 15.2 and 15.3 in the production plant shown in FIG. 4. Thus, all the relevant process parameters and product parameters of the entire process chain arrive at the process coordinating control system 5. The analyses and evaluations of the respective measuring signals are carried out within the process coordinating control system 5 in accordance with the preceding description.

As an example of the process control, it could be determined at the granulate preparation system 11 that the primary product has excessive moisture and thus an impermissible degree of dryness. However, this process parameter detected using the sensor means 3.1 would become noticeable in the thread wound to form a spool 29 only after a throughput time of approx. two hours. Assuming that the spools require a winding time of eight hours for completion, and this winding time would have lapsed only by 50% when determining and measuring the impermissible degree of dryness, a reduction in the quality of the polymer product would occur within the winding time of the currently wound spools. However, since the spools would have to be wound for still four hours up to completion and the quality defect of the product becomes noticeable after two hours, it is possible to generate corresponding control signals based on the inventive method by evaluating and analyzing the quality signals, wherein said control signals already carry out a spool change after a winding time of six hours. It would thus be ensured that the reduced fiber product is not wound into the already predominantly finished spool of good quality.

The method according to the invention is thus particularly advantageous in the production of extruded polymer products, which after completion are stored in the form of spools or cans or other means.

The structure of the inventive devices is likewise illustrated in the exemplary embodiments by way of example with respect to the process modules. Thus, the process chain can already include a polycondensation, which is directly upstream of the melt-spinning process. Likewise, the method according to the invention and the device according to the invention can be extended to include productions in which an intermediate product is provided, which is supplied to a subsequent treatment process after a defined throughput time. Thus, a continuous production is likewise possible while taking into account defined throughput times.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for controlling the quality during the production of an extruded polymer product from a synthetic primary product, in which the production of the polymer product takes place continuously in several successive process steps, said method comprising:
detecting at least one of a process parameter or a product parameter is detected in at least one of the process steps; and
comparing the process parameter or product parameter with one of a target value or target value range,
wherein one of at least one quality signal for determining the quality of the polymer product or a control signal for controlling one of the process steps is generated in accordance with this comparison, and wherein a measuring time and a throughput time are assigned to the process parameter or product parameter, the throughput time characterizing the material flow from the respective process step up to the production of the finished polymer product.

2. A method for controlling the quality during the production of an extruded polymer product from a synthetic primary product, in which the production of the polymer product takes place continuously in several successive process steps, said method comprising:
detecting at least one of a process parameter or a product parameter is in at least one of the process steps; and
comparing the process parameter or product parameter with one of a target value or target value range,
wherein one of at least one quality signal for determining the quality of the polymer product or a control signal for controlling one of the process steps is generated in accordance with this comparison, wherein a determination time is assigned to the quality signal or control signals and wherein when determining the quality signal or control signal, at least one of the process parameter, or the product parameters or the deviation of the process parameter or the product parameter from the target value or the target value range is consulted, where the process parameter, the product parameter, or the deviation thereof was detected in terms of time while taking into account the material flow at a throughput time before the determination time.

3. The method according to claim 1, wherein a measuring point is assigned to the process parameter or product parameter, by means of which measuring point the throughput time is determined.

4. The method according to claim 1, wherein a plurality of process parameters or product parameters are detected, and wherein the respective measuring time and the respective throughput time are assigned to each of the process parameters and/or each of the product parameters.

5. The method according to claim 4, wherein the process parameters or the product parameters are detected and stored consecutively.

6. The method according to claim 4, wherein the process parameters or product parameter having the same measuring time are consulted for generating the quality signal or the control signal.

7. The method according to claim 4, wherein the process parameters or product parameters having the same throughput time are consulted for generating the quality signal or the control signal.

8. The method according to claim 4, wherein process parameters or product parameters whose measuring time and throughput time result in an identical future determination time are consulted for generating the quality signal or the control signal.

9. The method according to claim 1, wherein a plurality of target values or target value ranges are assigned to at least one of the process parameter or product parameter, using which target values or target value ranges a weighting of the deviation of the process parameter or the product parameter is predetermined.

10. The method according to claim 9, wherein specifications of the target values or target value ranges are changeable.

11. The method according to claim 1, wherein the generation of the quality signal or the control signal is carried out by means of changeable algorithms.

12. The method according to claim 1, characterized in that wherein a thread is wound up as a polymer product to form a spool in a last process step, wherein a maximum thread quantity to be received by the spool is deposited on the spool in a winding time, and wherein the control signal brings about a spool change in the process step if the quality of the thread changes distinctly within the winding time.

13. A device for controlling the quality during the production of an extruded polymer product from a synthetic primary product, said device comprising:
a production plant for a polymer product, which is generated from at least one synthetic primary product and comprises a plurality of process modules;
a central process coordinating control system, which is connected to the process modules by means of a control and monitoring network,
wherein a sensor means is assigned to at least one of the process modules for detecting at least one of a process parameter or product parameter, wherein the process coordinating control system comprises a memory means for recording at least one of a target value or a target value range of the process parameter or product parameters and an evaluation electronic system for generating at least one of a quality signal or a control signal, wherein within the process coordinating control system, a means for digitizing the measuring signals with the measuring time and measuring point data is assigned to the sensor means, and wherein the memory means has a time register, in which at least one place-dependent throughput time is stored, wherein the throughput time characterize, material flow from the related process module up to the production of the finished polymer product.

14. The device according to claim 13, wherein the process coordinating control system comprises an interface for connecting a manual operating unit, by means of which specifications of the target values or the target value ranges as well as of the throughput time can be entered in the time register.

15. The device according to claim 13, wherein the process coordinating control system comprises an interface for connecting an output unit for displaying process parameters, product parameters, or quality signals.

16. The device according to claim 15, wherein the output unit is combined with the operating unit.
